(19) United States
(12) Patent Application Publication
(10) Pub. No.: US 2013/0042888 A1
(43) Pub. Date: Feb. 21, 2013

(54) SIPHONING AS A WASHING METHOD AND APPARATUS FOR HETEROGENEOUS ASSAYS

(71) Applicant: Piero Zucchelli, Versonnex (FR)

(72) Inventor: Piero Zucchelli, Versonnex (FR)

(21) Appl. No.: 13/504,327

(22) PCT Filed: Oct. 29, 2010
(86) PCT No.: PCT/IB2010/003302

§ 371 Date: Sep. 17, 2012

Related U.S. Application Data
(60) Provisional application No. 61/256,510, filed on Oct. 30, 2009.
(60) Provisional application No. 61/256,495, filed on Oct. 30, 2009.

(51) Int. Cl. B08B 3/14; B01L 99/00

(52) U.S. Cl. 134/10; 134/109; 134/56 R; 422/500; 422/527; 422/534; 422/537

(57) ABSTRACT

A fluidic tile having a first substrate containing macrofluidic structures bonded to a second substrate containing microfluidic structures. The microfluidic structures correspond to the macrofluidic structures in the first substrate and provide fluid flow paths between the macrofluidic structures. One of the microfluidic structures is a washing siphon that provides a fluid flow path between a purification chamber and a waste chamber. The washing siphon is configured to be primed when a volume of liquid in the purification chamber exceeds a predetermined amount causing the washing siphon to initiate transfer of the liquid in the purification chamber to the waste chamber when the volume of the liquid in the purification chamber exceeds the predetermined amount.

### CROSS REFERENCE TO RELATED APPLICATIONS

This application claims the benefit of U.S. Provisional Patent Application Ser. No. 61/256,495, filed on Oct. 30, 2009 and U.S. Provisional Patent Application Ser. No. 61/256,510, filed on Oct. 30, 2009, the contents of which are incorporated herein by reference in their entirety.

### FIELD OF THE DISCLOSURE

The present disclosure relates to the field of microfluidics and macrofluidics for chemical, biological, and biochemical processes or reactions. More specifically, it discloses siphon washing methods and apparatuses for heterogeneous assays.

### BACKGROUND OF THE DISCLOSURE

In recent years, the pharmaceutical, biotechnology, chemical and related industries have increasingly adopted devices containing micro-chambers and channel structures for performing various reactions and analyses. These devices, commonly referred to as microfluidic devices, allow a reduction in volume of the reagents and sample required to perform an assay. They also enable a large number of reactions without human intervention, either in parallel or in serially, in a very predictable and reproducible way. Microfluidic devices are therefore promising devices to realize a Micro Total Analysis System (micro-TAS), definition that characterizes miniaturized devices that have the functionality of a conventional laboratory.

In general, all attempts at micro-TAS devices can be characterized in two ways: according to the forces responsible for the fluid transport and according to the mechanism used to direct the flow of fluids. The former are referred to as motors. The latter are referred to as valves, and constitute logic or analogue actuators, essential for a number of basic operations such as volumetric quantitation of fluids, mixing of fluids, connecting a set of fluid inlets to a set of fluid outputs, sealing containers (to gas or to liquids passage according to the application) in a sufficiently tight manner to allow fluid storage, and regulating the fluid flow speed. A combination of valves and motors on a microfluidic network, complemented by input means to load the devices, and readout means to measure the outcome of the analysis, make a micro-TAS possible and useful.

Fluid handling devices, also called fluid handlers, dispensing devices, sample loading robots, compound dispensers, dispensing means, pipettors, and pipette workstations, have the purpose of transferring fluids, and in particular liquids, from fluid storage to further fluid storage. The components that take part in a typical fluid handling process can therefore be classified into three categories, according to their role in the process: (i) the source of the original fluid storage, (ii) the means by which the fluid is transferred, and (iii) the container in the fluid storage where the fluid is moved to.

In general terms, an automated dispensing device is not always strictly needed, since the dispensing operation could be performed by a human operator equipped with specific tools, like pipettors or similar devices. However, all dispensing devices can be described according to their overall characteristics, such as for example operational speed, performance, cost, contamination issues and versatility. The desired requirements of fluid handling devices are the highest speed possible (to achieve high productivity, but also to allow to perform assays in similar conditions like temperature, reagents activity, etc.), minimal contamination between sources and containers, minimal fixed cost and minimal cost per dispensing operation (consumables), performances (precision of dosing, range of volumes that can be dispensed, footprint, etc.) and versatility (multi-format compatibility, type of operations performed, automatic identification of source and container, etc.).

All existing fluid handling devices address or partially solve these requirements, and the user choice depends on the specific application and on the laboratory environment. Being the environments heterogeneous, the dispensing instruments—exactly as it is for the fluid storage means—differ significantly and adopt different technologies: disposable tips and suction means, metallic pins immerged in the fluids, aspirating needles and subsequent rinsing and cleaning operations, pumps and tubing, ejection of droplets by piezoelectric or other mechanical means. Also the infrastructure surrounding the dispensing technology and its degree of automation differ enormously, going from complex installations for compound libraries management in the pharmaceutical industry, to simple hand-held devices.

Centripetal devices are a specific class of microfluidic devices, where the micro-fluidic devices are spun around a rotation axis in such a way that the centripetal acceleration generates an apparent centrifugal force on the microfluidic device itself, and on any fluid contained within the microfluidic device. The centrifugal force acts as a motor, in the radial but also in the tangential direction if the angular momentum varies. This force, however, is applied at the same time to any material contained in the microfluidic device, including the fluids that are contained in the inlets. In most centripetal microfluidic devices, like for example those developed by Gyros AB, Tecan AG, Burstein Technologies Inc. for example, micro-fluidic devices have the shape of disks, and the rotation axis is perpendicular to the main faces and passing through the centre of the disk.

Heterogeneous assays are a common format in multiple biochemical applications. Heterogeneous assays are common, for example, in solid phase separation, immunoassays, nucleic acid extraction, enzyme-linked immunosorbent assays (ELISA), and bead-based assay technologies. Heterogeneous assays are performed, for example, by means of columns (for example, columns containing gels, powders, and beads), coated surfaces (for example, ELISA microplates, and lateral flow strips), and beads (for example, magnetic or non-magnetic, glass, polystyrene, silica, nanocrystal, polymeric surface and PS streptavidin beads).

As an example, beads may be used in nucleic acid purification. A sample can be introduced into a container together with beads. A portion of the sample may selectively interact with the beads, and bind to the beads. The sample which has not interacted with the beads may be removed by means of extraction and/or dilution with a washing buffer. The washing buffer is generally chosen so as not to interfere with the binding properties of the sample attached to the beads. The addition of an elution buffer changes the interaction of the sample attached to the beads, with the consequence of releasing the sample. The sample can then be collected by the elution buffer and made available to a next step of the protocol.

As another example, beads may be used in an immunoassay. A sample can be introduced into a container together with beads. A portion of the sample may selectively interact with the beads, and bind to the beads. The sample which has not interacted with the beads may be removed by means of extraction and/or dilution with a washing buffer. The washing buffer is generally chosen so as not to interfere with the binding properties of the sample attached to the beads. Then the addition of a different solution may allow the detection of the amount of sample still bound to the beads, and generate a signal correlated with the sample quantity.

In general, a number of washing methodologies have been used in beads manipulations. Some examples of washing procedures include, application of a continuous washing flux along with the application of a magnetic field to collect the beads, fluidic trapping of the beads in vortices inside a capillary, filtering of the beads, solvents evaporation at atmospheric pressure, water evaporation in a vacuum, and water evaporation by heating. However, it can be difficult to manufacture beads with homogeneous properties and to achieve uniform dimensions of the coating around the core. Efficiency in the washing procedures may be an issue because it can be difficult to minimize the losses of the sample attached to the beads during the washing procedure, and/or the loss of the beads themselves, for example as a result of beads with reduced paramagnetic properties

Contamination may also be an issue because a portion of the sample not attached to the beads could resist to the washing action, and remain together with the bead-ligated sample, for example when there is a presence of liquid or fluid in the minute cavities between clustered beads. Further, reproducibility may be an issue as a result of efficiency and contamination, for example the may be lab-to-lab variability in the washing quality performed by means of a pipettor.

### SUMMARY OF THE DISCLOSURE

The present disclosure is directed towards a method and apparatus for siphon washing. The method may include implementing a washing siphon for partial or complete washing of a heterogeneous assay. The purpose of the siphon washing may be to wash beads within a purification or reaction chamber and extract a washing liquid from the purification chamber for further processing, discard the washing liquid, and/or modify the remaining conditions. The behavior of the siphon may be governed by gravity and/or by inertial acceleration. The governing force could either be constant or variable (like in centrifugation, both spatially and in time). The force governing the behavior of the siphon may be used, either simultaneously or separately, to perform separation steps for different phases of the same assay, for example beads pelleting, cells separation, and/or blood fractionation.

A valve-triggered siphon may be implemented and may allow for deciding precisely when the washing step is to occur, irrespectively of the amount of liquid in the purification or reaction chamber. A user of the disclosed washing siphon may not perceive any difference with respect to a homogeneous or heterogeneous assay because the washing is transparent to the user, and is governed, for example, by self-priming or valve-triggering.

A self-priming siphon can be implemented to moderate the volume or level of liquid in a chamber, alternatively between a full and empty condition almost independently of the flow time evolution of the entering liquid. Through the use of a self-priming siphon, priming of the siphon may be triggered according to the volume of liquid contained in the reaction chamber. Thus, through the use of a self-priming siphon the purification or reaction chamber can be emptied automatically, without the need for human intervention, when the volume of liquid in the purification or reaction chamber reaches a predetermined level.

The washing siphon may allow for a predictable and reproducible washing actions, since the fluidic configuration is reproducible and defined without external means. The washing siphon can guarantee complete liquid extraction from the purification or reaction chamber, without leaving undesired amount of washing liquids behind. The washing siphon may allow for converting a continuous washing step flow into an intermittent chain of discrete washing volumes, improving de facto the washing efficiency. The siphon-induced washing can be repeated as many times as desired, which is different from irreversible valving mechanisms.

The washing siphon may be implemented as a microfluidic component in a fluidic tile in which fluid flow is regulated by putting a microfluidic component and a macrofluidic component that are initially separated into fluid communication. Both the time at which the two components are connected and the position of such fluid communication are arbitrary and can be determined externally. Accordingly, the disclosure describes an infinite number of virtual valves, all of which are initially in the closed state, but may be opened at any time, at multiple locations that do no need to be predetermined and in any order.

When a virtual valve according to the disclosure is closed, a fluid, gas or solid and mixtures thereof may be contained in a first macrofluidic component. As soon as the virtual valve is opened, communication is enabled to at least one or more additional microfluidic or macrofluidic components through at least one microfluidic component. Whether the fluid, gas or solid and mixtures thereof will flow into the additional components, to what extent and at which speed, depends on the forces acting on the fluid gas or solid and mixtures thereof and the impediments to flow through valving components.

In microfluidic circuits, fluid transport may be achieved through the use of gravitational forces, mechanical micropumps, electric fields, application of acoustic energy, external pressure, or inertial acceleration (for example centripetal force). A valve according the disclosure is independent of the mechanism for fluid transport and is therefore compatible with, but not limited to, any of the above means for fluid transport.

Accordingly, in one aspect of the present disclosure, an apparatus for implementing a washing siphon process includes a microfluidic substrate comprising a plurality of microfluidic components or structures, including a siphon, and a macrofluidic substrate comprising a plurality of macrofluidic components or structures corresponding to the microfluidic components or structures. It is contemplated within the scope of the disclosure that the inventive apparatus may further comprise additional substrate layers. According to the disclosure, these additional substrate layers can contain a plurality of fluidic channels, chambers and manipulative components or structures such as lenses and filters.

The macrofluidic substrate may include chambers which may contain reagents, samples, biological samples, and the like for performing a desired process. The chambers within the macrofluidic substrate may correspond to microfluidic structures in the microfluidic substrate such that the chambers within the macrofluidic substrate may be placed in fluid communication with additional chambers in the macrofluidic substrate and/or microfluidic substrate. In an illustrative embodiment the macrofluidic substrate includes a purification or reaction chamber and a waste chamber and the microfluidic substrate includes a microfluidic siphon that can place the purification or reaction chamber in fluid communication with the waste chamber.

Use of a washing siphon for partial or complete washing of a heterogeneous assay within an embodiment of the fluidic tile according to the disclosure may result in more efficient processing of assays. Currently, partial or complete washing of a heterogeneous assay may require multiple steps to be performed individually by the preparer, such as preparing and transferring liquids from one container to another, reacting, mixing, purifying, and the like with multiple different devices. Through the use of an illustrative embodiment of the present disclosure a preparer may only have to add a single sample that is to be prepared, and all of the additional steps may be performed within the tile, including an automated siphoning process which may remove a washing liquid from a purification or reaction chamber. Thus, embodiments of the present disclosure may increase the efficiency of performing a desired process or procedure, eliminate the possibility of human error within the process or procedure, minimize the possibility of external agents contaminating the sample, minimize the possibility of contaminating the environment, and allow for accurate repeatable measurements to be taken of samples within the tile.

These and other advantages, objects, and features of the disclosure will be apparent through the detailed description of the embodiments and the drawings attached hereto. It is also to be understood that both the foregoing general description and the following detailed description are exemplary and not restrictive of the scope of the disclosure.

### BRIEF DESCRIPTION OF THE DRAWINGS

These and other advantages, objects and features of the disclosure will be apparent through the detailed description of the embodiments and the drawings attached hereto. It is also to be understood that both the foregoing general description and the following detailed description are exemplary and not restrictive of the scope of the disclosure.

FIG. 1 illustrates embodiment of a siphoning effect;

FIG. 2 illustrates an embodiment of a schematic of a washing siphon for partial or complete washing of a liquid assay;

FIG. 3 illustrates an embodiment of a fluidic tile incorporating siphon washing;

FIG. 4 illustrates an embodiment of a washing siphon for partial or complete washing of a liquid assay within a fluidic tile;

FIG. 5 illustrates an embodiment of regulating the siphon washing within the fluidic tile using virtual laser valves;

FIG. 6 illustrates an embodiment of a binding step in a method of siphon washing within the fluidic tile using virtual laser valves;

FIGS. 7 and 8 illustrate an embodiment of a supernatant extraction step in a method of siphon washing within the fluidic tile using virtual laser valves;

FIG. 9 illustrates an embodiment of a washing step in a method of siphon washing within the fluidic tile using virtual laser valves;

FIG. 10-11 illustrate an embodiment of a siphoning step in a method of siphon washing within the fluidic tile using virtual laser valves;

FIG. 12 illustrates an embodiment of an elution step in a method of siphon washing within the fluidic tile using virtual laser valves;

FIG. 13 illustrates an embodiment of collecting a sample in a method of siphon washing within the fluidic tile using virtual laser valves; and

FIG. 14 illustrates an embodiment of a method of manufacturing a fluidic tile.

### DETAILED DESCRIPTION OF THE DISCLOSURE

Detailed embodiments of the present methods and apparatuses for using siphoning as a washing procedure for heterogeneous assays are disclosed herein, however, it is to be understood that the disclosed embodiments are merely exemplary of the present methods and apparatuses, which may be embodied in various forms. Therefore, specific functional details disclosed herein are not to be interpreted as limiting, but merely as a basis for the claims and as a representative basis for teaching one skilled in the art to variously employ the present methods and apparatuses for using siphoning as a washing procedure for heterogeneous assays.

For the purpose of this disclosure no distinction should be made between inputs, inlets, outlets, ports, connections, wells, chambers, reservoirs and similar words, all referring to the means by which fluids can enter, or exit, from the fluidic network.

For the purposes of this disclosure, the term “sample” will be understood to encompass any fluid, reagent, solution or mixture, either isolated or detected as a constituent of a more complex mixture, or synthesized from precursor species.

For the purposes of this disclosure, the term “in fluid communication” or “fluidly connected” is intended to define components that are operably interconnected to allow fluid flow between components. In illustrative embodiments, the analytical platform comprises fluidic tiles, whereby fluid movement on the tile is motivated by centripetal force upon rotation of the tile and/or fluid movement on the tile is motivated by gravitational forces.

For the purposes of this specification, the term “biological sample”, “sample of interest” or “biological fluid sample” will be understood to mean any biologically-derived analytical sample, including but not limited to DNA, blood, plasma, serum, lymph, saliva, tears, cerebrospinal fluid, urine, sweat, plant and vegetable extracts, semen, water, food or any cellular or cellular components of such sample.

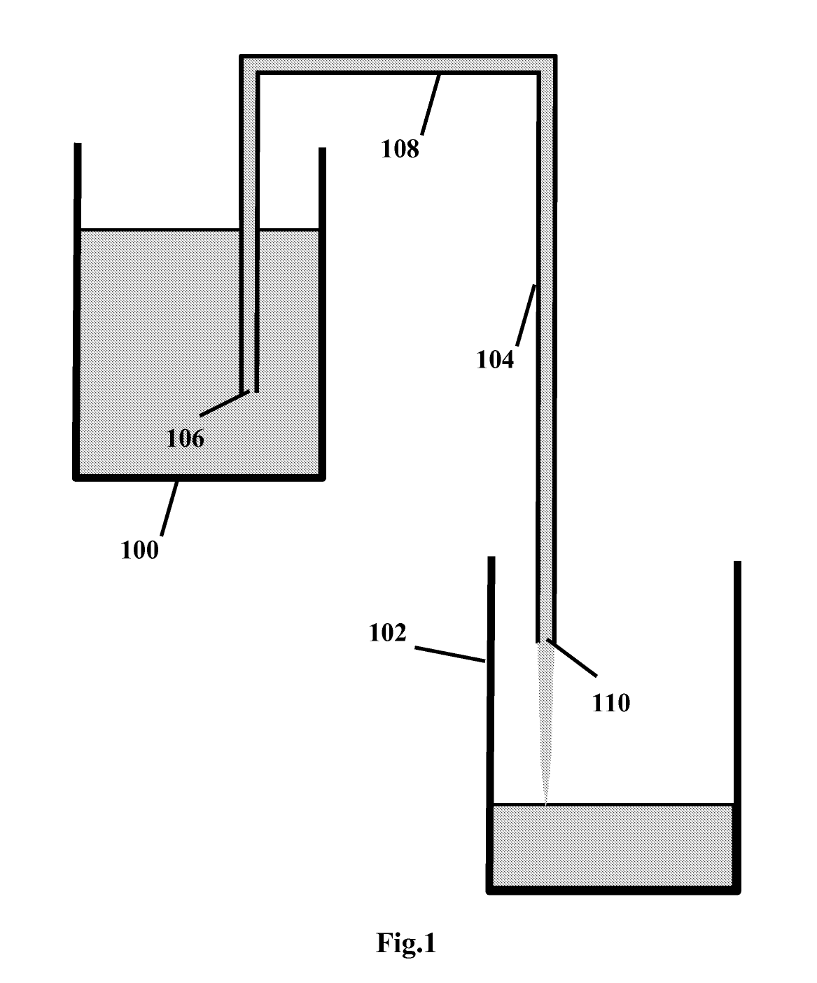

A siphoning effect according to an illustrative embodiment is described with reference to FIG. 1. An upper reservoir 100 containing a fluid and a lower reservoir 102 may be fluidly connected by a siphon 104. The siphon 104 operates to transfer a fluid, in particular a liquid, contained in the upper reservoir 100 to the lower reservoir 102. The liquid in the upper reservoir 100 enters the siphon 104 at an inlet point 106 within the upper reservoir 100. The liquid then travels from the inlet point 106 up the siphon 104 to a high point 108 on the siphon 104, which is above the surface of the liquid in the upper reservoir 100. The liquid then travels from the high point 108 down to a discharge point 110 on the siphon 104, which is within the lower reservoir 102.

The siphon 104 transports the liquid in the upper reservoir 100 to the lower reservoir 102 because gravity causes the hydrostatic pressure of the liquid at the discharge point 110 of the siphon 104 to be greater than the surrounding pressure in the lower reservoir 102. When the discharge point 110 discharges into the atmosphere the hydrostatic pressure of the liquid at the discharge point 110 of the siphon 104 is greater than atmospheric pressure. The liquid is drawn into the siphon 104 at the inlet point 106 and rises above the surface of the upper reservoir 100 because gravity causes the hydrostatic pressure of liquid near the high point 108 of the siphon 104 to be less than atmospheric pressure.

The maximum height of the high point 108 above the surface of the liquid in the upper reservoir 100 is limited by the pressure at the surface of the liquid in the upper reservoir 100 and the pressure at the discharge point 110 (atmospheric pressure), the density of the liquid, and the liquid's vapour pressure. When the pressure within the liquid drops to below the liquid's vapor pressure, vapor bubbles may begin to form at the high point 108 and the siphon effect will be lost. For water at standard atmospheric pressure, the maximum height of the high point 108 above the surface of the liquid in the upper reservoir 100 is approximately thirty three feet.

Once initiated, the siphon 104 requires no additional energy to keep the liquid flowing up and out of the upper reservoir 100. The siphon 104 may draw liquid out of the upper reservoir 100 until the level in the upper reservoir 100 falls below the intake point 106, allowing air or other surrounding gas to break the siphon effect. Further, when applying the siphon effect to any application can be important that the fluid flow path of the siphon 104 be closely sized to the requirements. The fluid flow path may be for example piping, tubing, capillaries, and other pathways capable of carrying a liquid. Using a fluid flow path having too great a cross sectional dimension or diameter and throttling the flow using valves or constrictive fluid flow paths appears to increase the effect of gases or vapor collecting in the high point 108 which may serve to break the vacuum and cause the siphoning effect to be lost.

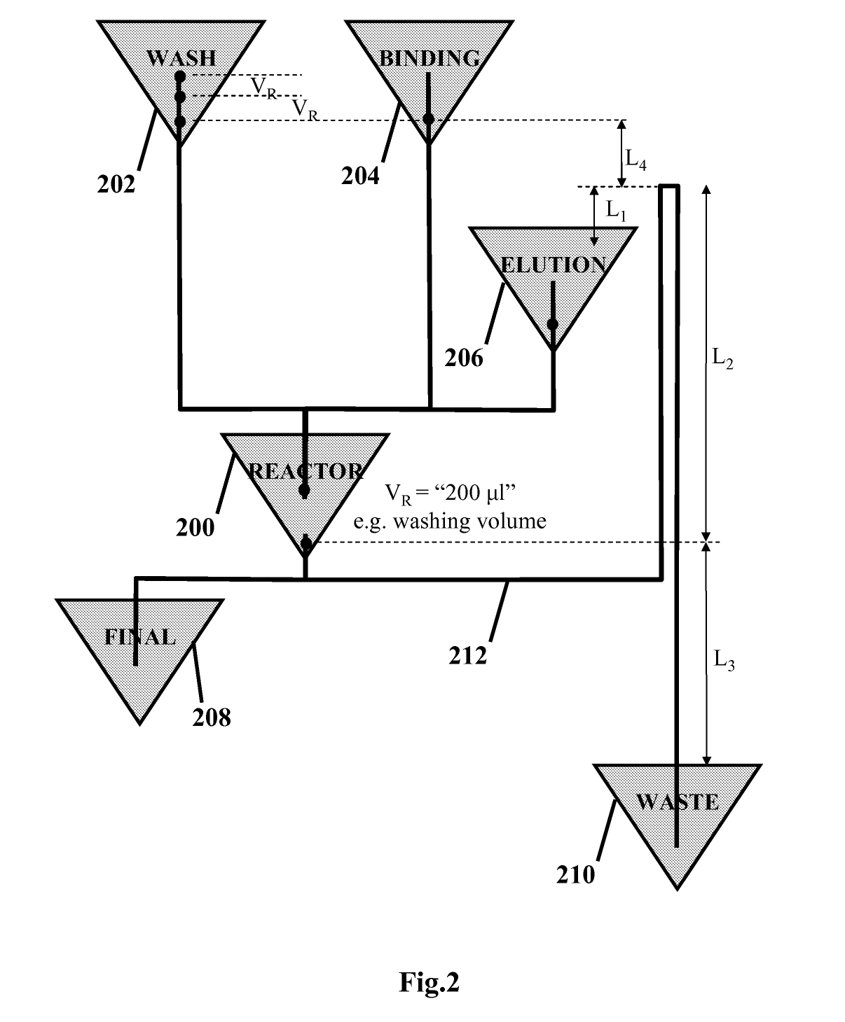

A schematic of a washing siphon for partial or complete washing of a liquid assay according to an illustrative embodiment is described with reference to FIG. 2. The washing siphon schematic includes a reactor chamber 200, a washing buffer chamber 202, a binding sample chamber 204, an elution buffer chamber 206, a final sample chamber 208, and a waste chamber 210. The washing buffer chamber 202, the binding sample chamber 204, and the elution buffer chamber 206 may be placed in fluid communication with the reactor chamber 200. The reactor chamber 200 may be placed in fluid communication with the final sample chamber 208. The reactor chamber 200 may be placed in fluid communication with the waste chamber 210, via a siphon 212. The siphon is the fluidic path between the reaction chamber 200 and the waste chamber 210.

The siphon 212 has a height which is a distance L₂ above the outlet of the reaction chamber 200, wherein the distance L₂ is greater than zero. The siphon 212 extends to a height which is a distance L₁ above the elution buffer chamber 206 and/or a liquid contained in the elution buffer chamber 206, wherein the distance L₁ is greater than zero. The distance L₁ is greater than zero to prevent any liquid (elute) contained in the reaction chamber 200 from flowing through the siphon 212 to the waste chamber 210, instead of flowing to the final sample chamber 208 when collecting an elution buffer and sample (elute) in the reaction chamber 200.

The siphon 212 extends to a height which is a distance L₄ below the outlet of the washing buffer chamber 202 and the binding sample chamber 204, wherein the distance L₄ is greater than zero. The distance L₄ is greater than zero to prevent any liquid contained in the reaction chamber 200 from flowing back into the washing buffer chamber 202 and/or the binding sample chamber 204, instead of flowing to the waste chamber 210 via the siphon 212 when washing the beads to remove any of the remaining sample that does not interact and bind to the beads.

The waste chamber 210 is positioned at a distance L₃ below the outlet of the reaction chamber 200, or the distance L₃ between the liquid level in the waste chamber 210 to the liquid level in the reaction chamber 200, wherein the distance L₃ is greater than zero. The distance L₃ is greater than zero to allow for liquid to flow from the reaction chamber 200 to the waste chamber 210 via the siphon 212.

In an illustrative embodiment, the flow path through the siphon 212 has a geometrical volume from the reaction chamber 200 to its highest point which is small compared to the volume of liquid in the reaction chamber 200 thereby ensuring a smooth flow. Additionally, the flow paths, including the flow path through the siphon 212, may be large enough for particulate solutions (for example, cells and/or beads) to flow as easily as homogeneous liquids through the flow paths while being small enough for the siphoning effect not to be broken easily by the formation of bubbles. In one example the flow paths, including the flow path through the siphon 212, may have a cross sectional dimension or diameter of about 50 microns to at least 1 mm. Preferably, the flow paths may have a cross sectional dimension or diameter of about 300 microns.

In an illustrative example, a method of siphon washing for partial or complete washing of a liquid assay begins by fluidly connecting the binding sample chamber 204 with the reaction chamber 200. A sample contained in the binding sample chamber 204 flows into the reaction chamber 200 together with beads (for example, magnetic or non-magnetic, glass, polystyrene, silica, nanocrystal, polymeric surface and PS streptavidin beads). A portion of the sample selectively interacts with the beads and binds to the beads. Fluid flow between the reaction chamber 200 and the waste chamber 210 may then be initiated. The supernatant in the reaction chamber 200 may be extracted from the reaction chamber 200 and transferred to the waste chamber 210, via the siphon 212. The washing buffer chamber 202 may be fluidly connected to the reaction chamber 200. A washing buffer contained in the washing buffer chamber 202 then flows into the reaction chamber 200. Preferably, the washing buffer does not interfere with the binding properties of the sample attached to the beads, but washes the beads to remove any of the remaining sample that did not interact and bind to the beads. The washing buffer may then be removed from the reaction chamber 200 and transferred to the waste chamber 210, via the siphon 212. In an illustrative embodiment, after the washing buffer has been transferred to the reaction chamber 200, but prior to transferring the washing buffer from the reaction chamber 200 to the waste chamber 210 via the siphon 212, it may be advantageous to resuspend the bead solution into the washing buffer and repellet the beads at the bottom of the reaction chamber 200 prior to directing the excess washing buffer to waste chamber 210 via the siphon 212.

Then the sample attached to the beads in the reaction chamber 200 may be removed and transferred to the final sample chamber 208. To remove the sample from the reaction chamber 200, the elution buffer chamber 206 may be fluidly connected to the reaction chamber 200. An elution buffer contained in the elution buffer chamber 206 may flow into the reaction chamber 200. Preferably, the elution buffer changes the interaction of the sample attached to the beads to release the sample from the beads. The elution buffer and sample (elute) in the reaction chamber 200 may be transferred to the final sample chamber 208 by fluidly connecting the reaction chamber 200 with the final sample chamber 208. The final sample chamber 208 may allow the sample to be available to a next step of a protocol or for further processing.

More specifically, fluid flow from the reaction chamber 200 to the waste chamber 210 via the siphon 212 may be initiated by priming the siphon 212. Priming the siphon 212 involves causing the fluid flow path of the siphon 212 to be filled with enough liquid to cause the hydrostatic pressure of the liquid at the discharge point of the siphon 212 in the waste chamber 210 to be greater than the surrounding pressure in the waste chamber 210.

The siphon 212 may be primed in a number of different ways including, but not limited to, by increasing the pressure applied onto the reaction chamber 200, by decreasing the pressure applied on the siphon 212 connected to the reaction chamber 200, by a valve opening or closing, by a pump, by self-priming, and/or by a bell (which incorporates gas-induced liquid displacement). A self-priming siphon may transform the reaction chamber 200 into a self-washing chamber by initiating fluid flow between the reaction chamber 200 and the waste chamber 210 when the amount of liquid in the reaction chamber 200 exceeds a predetermined amount. A valve-triggered siphon may allow for deciding precisely when the washing step is to occur, irrespectively of the amount of liquid in the reaction chamber 200. A user of the disclosed washing siphon may not perceive any difference with respect to a homogeneous or heterogeneous assay because the washing is transparent to the user, and is governed, for example, by self-priming or valve-triggering.

A self-priming siphon can be used to moderate the volume or level of liquid in a chamber, alternatively between a full and empty condition almost independently of the flow time evolution of the entering liquid. Through the use of a self-priming siphon, priming of the siphon 212 may be triggered according to the volume of liquid contained in the reaction chamber 200. Through the use of a self-priming siphon, priming of the siphon may be triggered according to the volume of liquid contained in the reaction chamber 200. In an illustrative embodiment, a self-priming siphon is primed when the volume of liquid in the reaction chamber 200 reaches a predetermined volume (for example 200 μL). When the volume of liquid in the reaction chamber 200 reaches, for example, 200 μL the siphon is primed and initiates fluid flow through the flow path of the siphon to the waste chamber 210.

The purpose of the washing may be, for example to extract the washing liquid for further processing, discard the washing liquid, and/or modify the remaining conditions (for example, oxygen exchange). The liquid being siphoned may be homogeneous or heterogeneous, for example the liquid may contain beads, cells, and/or particles. The liquid may be a homogeneous or heterogeneous mixture of different liquids, for example water, alcohols, solvents, and/or biological samples. The liquid may be a homogeneous or heterogeneous mixture of different liquids, when applicable for different and varying atmospheric pressures.

The behavior of the siphon 212 may be governed by gravity and/or by inertial acceleration (for example, a centrifugal force). The governing force could either be constant or variable (like in centrifugation, both spatially and in time). The force governing the behavior of the siphon 212 may be used, either simultaneously or separately, to perform separation steps for different phases of the same assay, for example beads pelleting, cells separation, and/or blood fractionation.

The washing siphon may allow for a predictable and reproducible washing actions, since the fluidic configuration is reproducible and defined without external means. The washing siphon can guarantee complete liquid extraction from the reaction chamber 200, without leaving undesired amount of washing liquids behind. The washing siphon may allow for converting a continuous washing step flow into an intermittent chain of discrete washing volumes, improving de facto the washing efficiency. The siphon-induced washing can be repeated as many times as desired, which is different from irreversible valving mechanisms like septa being broken, etc.

The washing siphon may be implemented in a specific device or apparatus, but also may be implemented on general purpose formats like microplates, Eppendorf tubes, and conventional tubes used in biochemistry and chemistry. In an illustrative embodiment, the washing siphon for partial or complete washing of a liquid assay may be implemented in fluidic tiles, which could be of the type described in the Patent Application PCT/US2010/031411, the teachings of which are incorporated herein by reference. The fluidic tiles may be used within centripetal systems, such as but not limited to centrifugal rotors, and microfluidic platforms as well as a number of its applications for providing centripetally-motivated fluid micromanipulation and macromanipulation. However, the means disclosed herein are equally applicable in microfluidic and macrofluidic components relying on other forces to effect fluid transport, for example gravitational forces, mechanical micropumps, electric fields, application of acoustic energy, and external pressure.

Representative applications of fluidic tiles within a centripetal system (e.g., centrifuge) employ rectangular shaped devices, with the rotation axis positioned outside the device's footprint. For the purpose of illustration, the drawings, as well as the description, will generally refer to such devices. Other shapes other than rectangular shaped devices should be appreciated to be within the scope of the disclosure including but not limited to elliptical and circular devices, irregular surfaces and volumes, and devices for which the rotation axis passes through the body structure, may be beneficial for specific applications.

Mixing may also be performed by shaking within a centripetal system. For example, in an illustrative embodiment, the centripetal system may be programmed to execute a sequence of accelerations, such as to about 1000 rpm, in one direction followed by a sudden deceleration in the alternate direction. As another example, the acceleration could be applied onto a rotating rotor, by means of magnets, electromagnets, springs or mechanical elements. The rotor could resonate accordingly and generate an oscillation, energized by the rotation, that induces enhanced mixing of the samples. This may allow for a number of reagents, samples, biological samples, or the like to be mixed together within the tiles in a centripetal system, as well as resuspension of particles contained in a liquid.

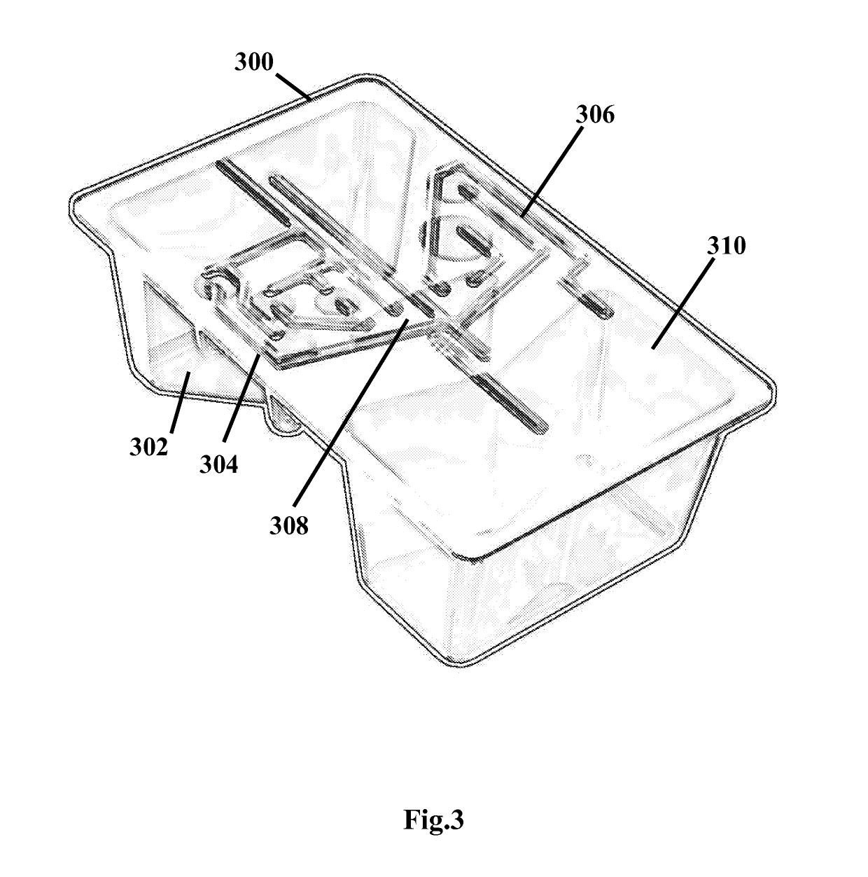

A fluidic tile incorporating siphon washing according to an illustrative embodiment is described with reference to FIG. 3. The fluidic tile 300 is a substantially planar object formed from a first substrate (a macrofluidic substrate) and a second substrate (a microfluidic substrate). It should be appreciated that the fluidic tile 300 can be formed from more than two substrates. The first and second substrates can be of any geometric shape. The first substrate contains depressions, voids or protrusions that form macrofluidic structures 302. The second substrate contains depressions, voids or protrusions that form microfluidic structures 304. Although the second substrate is illustrated as having microfluidic structures 304, the second substrate may also contain macrofluidic structures. The microfluidic structures 304 within the second substrate may correspond to the macrofluidic structures 302 within the first substrate when the first and second substrates are bond together. The microfluidic structures 304 and the macrofluidic structures 302 may be composed of a series of valves, chambers, reservoirs, reactors, capillaries, reaction chambers, reaction columns, elution columns, electrophoresis chambers, ion exchange matrixes, microreactors and microcapillaries, and/or other structures of the type.

In an illustrative embodiment, the first and second substrates have a film layer sandwiched between them. The film layer allows for separation of voids within the substrates forming microfluidic circuits 304 that can be placed in fluid communication with the macrofluidic structures 302 contained within substrate by perforation of the film layer. The first and second substrates may be joined within the film layer in between them. Further, the film layer may be perforated by electromagnetic radiation from an electromagnetic generating means. The film layer may be a valving matrix, which could be of the type described in the Patent Application WO04050242A2 ('242 application), wherein the film layer is perforated to actuate a valve. The teachings of the '242 application are incorporated herein by reference.

As illustrated in FIG. 3, the fluidic tile 300 is a substantially rectangular structure having a plurality of macrofluidic structures 302, such as wells or chambers, and a plurality of microfluidic structures 304 adapted to provide fluid flow paths between the macrofluidic structures 302. The macrofluidic structures 302 may be placed in fluid communication with at least one other fluid handling macrofluidic structure 302 contained in the first substrate and/or may be placed in fluid communication with at least one microfluidic circuit 304 contained within the second substrate. The microfluidic structures 304 may contain a washing siphon 306. The washing siphon 306 may provide a fluid flow path between a chamber 308 and a chamber 310.

The functionality of a specific microfluidic structure or circuit 304 and/or a specific macrofluidic structure 302 can be configured within the fluidic tile 300 to perform desired assays, reactions, washing procedures, and/or other procedures upon a selected sample or biological sample. It should be appreciated that any microfluidic, macrofluidic, or fluidic assay, reaction, or procedure can be configured within the fluidic tile 300 to achieve a desired functionality. Further, the fluidic tile 300 may be capable of performing such processes or procedures using the sample volumes known in the art. For example, it should be appreciated that one or more of the steps and processes for nucleic acid purification, and processing an immunoassay may be incorporated in the fluid tile 300.

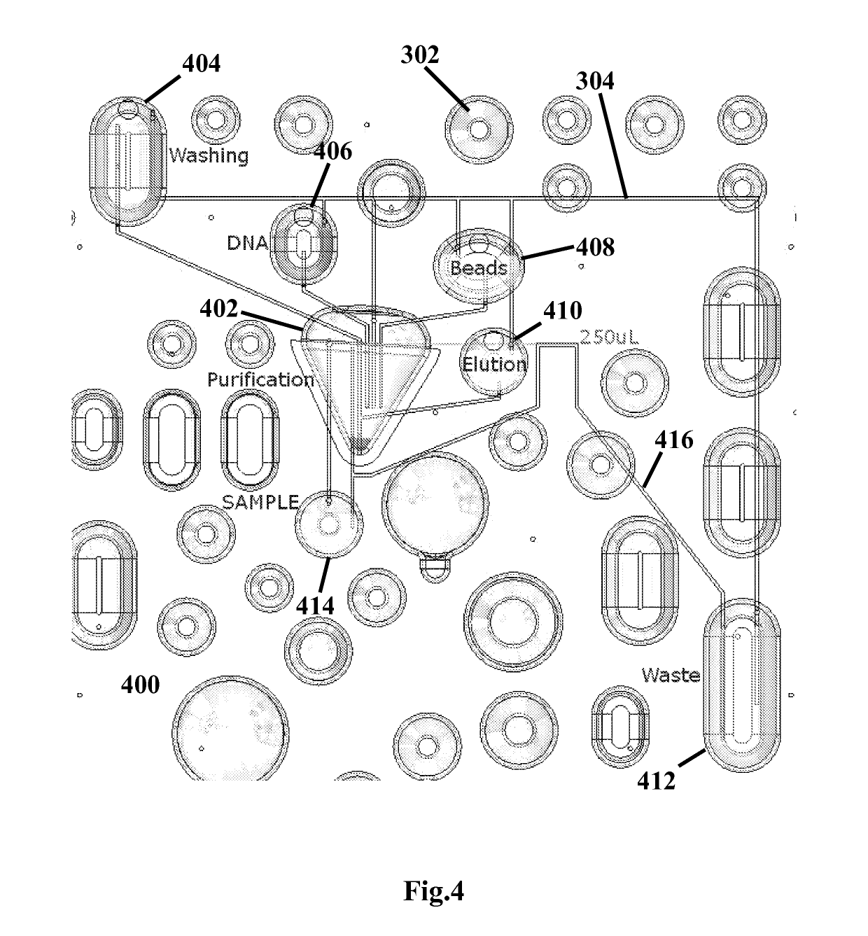

A washing siphon for partial or complete washing of a liquid assay within a fluidic tile according to an illustrative embodiment is described with reference to FIG. 4. As illustrated, a fluidic tile 400 contains macrofluidic structures 302 in the first substrate, including a purification chamber 402, a washing chamber 404, a sample chamber 406, a beads chamber 408, an elution chamber 410, a waste chamber 412, and a sample collection chamber 414. The macrofluidic structures 302 may have a volume of about one to several hundred microliters, or a volume up to about several millilitres. In an illustrative embodiment the purification chamber 402, the sample chamber 406, the beads chamber 408, the elution chamber 410, and the sample collection chamber 414 have a volume of about one to several hundred microliters, and the washing chamber 404 and the waste chamber 412 a volume of about a fraction of a milliliter to about several millititers.

The fluidic tile 400 contains microfluidic structures 304 in the second substrate that correspond to the macrofluidic structures 302. The microfluidic structures 304 include a washing siphon 416. The washing siphon 416 is a fluid flow path between the purification chamber 402 and the waste chamber 412. In an illustrative embodiment, the flow path through the washing siphon 416 has a geometrical volume from the purification chamber 402 to its highest point which is small compared to the volume of liquid in the purification chamber 402 thereby ensuring a smooth flow. Additionally, the flow paths, including the flow path through the washing siphon 416, may be large enough for particulate solutions (for example, cells and/or beads) to flow as easily as homogeneous liquids through the flow paths while being small enough for the siphoning effect not to be broken easily by the formation of bubbles. In an illustrative example the flow paths, including the flow path through the washing siphon 416, may have a cross sectional dimension or diameter of about 50 microns to at least 1 mm. Preferably, the flow paths may have a rectangular cross section of 333 microns×333 microns. As illustrated, for the washing siphon 416 having a rectangular cross section of 333 microns×333 microns, the length occupied by about 1 microliter is about 1 cm. Consequently, for liquid volumes of several hundred microliters being manipulated, the volume of liquid in the washing siphon 416 several centimeters long should be a low percentage of the total volume of liquid in the purification chamber 402.

The siphon 416 is positioned in fluid communication with the purification chamber 402 to be primed when the volume of liquid within the purification chamber 402 exceeds 250 μL. In an illustrative embodiment, the siphon 416 is a self-priming siphon. The siphon 416 is primed when the volume of liquid in the purification chamber 402 reaches a predetermined volume (for example 250 μL). When the volume of liquid in the purification chamber 402 exceeds 250 μL the liquid automatically fills the siphon 416, provided the waste chamber 412 is ventilated or at least is not at a pressure higher than the purification chamber 402. As soon as the liquid level in the purification chamber 402 exceeds the height of the siphon 416, the siphon 416 is primed and initiates fluid flow through the flow path of the siphon 416 to the waste chamber 412.

The point where liquid in the purification chamber 402 enters the siphon 416 is positioned to be below the level of liquid in the purification chamber 402 when the level of liquid in the purification chamber reaches 250 μL. If the entrance of the siphon 416 is positioned too high, for example above or just below the level of liquid in the purification chamber 402, the amount of pressure exerted by the liquid above the entrance of the siphon 416 may be insufficient for any liquid to flow if capillary tension is to be overcome, in particular for narrow siphon cross sections or diameters. On the other hand, if the entrance of the siphon 416 is positioned too low, for example at the very bottom of the purification chamber 402, particulate matter (for example, beads) in the purification chamber 402 may flow out of the purification chamber 402 along with the liquid. Thus, advantageously the entrance of the siphon 416 may be positioned to be as low as possible while still being above the level defined by the volume occupied by the particulate matter in the purification chamber 402 when the particulate matter is pelleted at the bottom of the purification chamber 402.

The purification chamber will behave as a closed chamber if the volume of liquid within the purification chamber 402 does not exceed 250 μL because the siphon 416 will not become primed. When, the volume of liquid within the purification chamber 402 does exceed 250 μL the siphon 416 will become primed and the amount of liquid above the fluidic connection of the siphon 416 to the purification chamber 402 will completely flow to the waste chamber 412. After the siphon washing or operation the siphon 416 will completely empty into the waste chamber 412. Then a new liquid can be inserted into the purification chamber 402 and the purification chamber 402 should behave exactly as if the purification chamber 402 has not been used before.

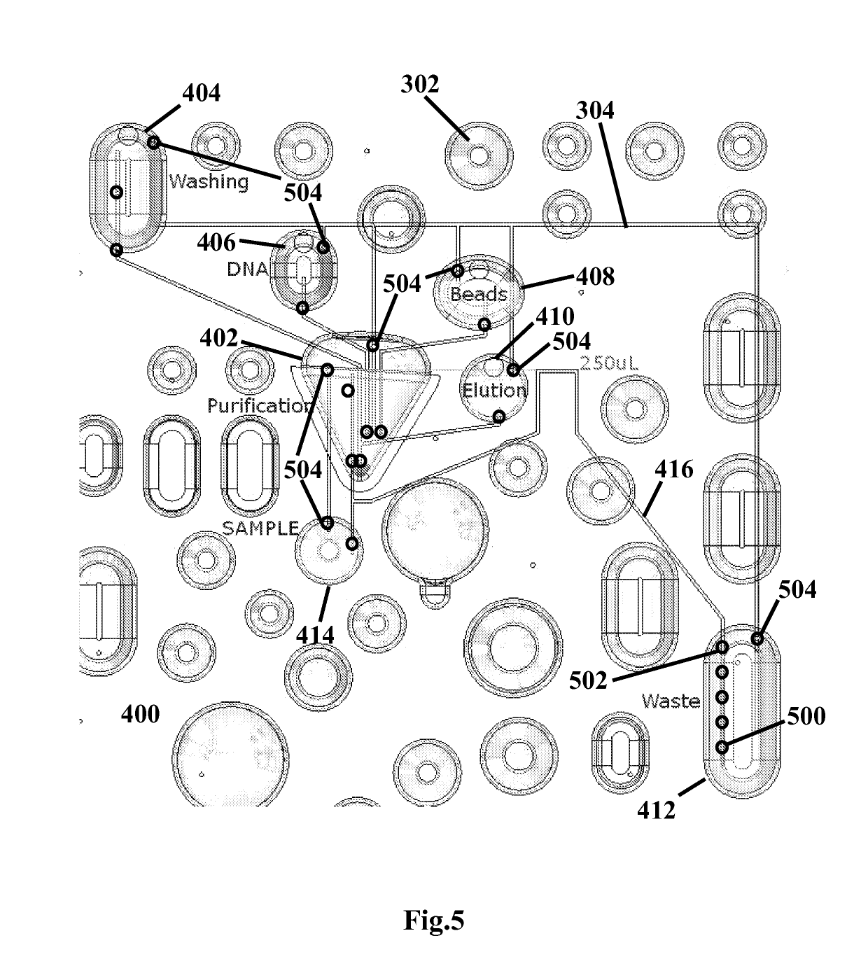

Regulating the siphon washing within the fluidic tile 400 using virtual laser valves according to an illustrative embodiment is described with reference to FIG. 5. The macrofluidic structures 302 contained within the first substrate of the fluidic tile 400 and the microfluidic structures 304 contained within the second substrate of the fluidic tile 400 are positioned onto a different plane with respect to connecting capillaries within a valving matrix, and they are separated by means of a film layer that can be perforated at a selected location(s) by irradiation, therefore producing a virtual laser valve.

The fluid handling process of the siphon washing method is initiated by the opening of a virtual laser valve to place the macrofluidic structures 302 and the microfluidic structures 304 in fluid communication, and the application of a force directed towards the bottom of the fluidic tile 400, such as gravity or inertial acceleration on the fluid may cause the fluid to flow. However, the valving mechanism could also be of different types known in the art such as a mechanical valve or the like. The amount of liquid or fluid that is subject to movement may be determined by the position of the valves, since only the fluid contained above the corresponding valve is allowed to move through the valve. The process could be replicated in a plurality of subsequent layers, giving the possibility of successive dilution over various orders of magnitude, mixing two or more type of liquids together, incubating fluids for a given amount of time into the reactors, or even performing a real-time protocol over the matrix layers.

The virtual laser valves may be used in siphon washing to prime the siphon 416. In particular virtual laser valves may be used to prime and/or control the siphon 416 when the valve separates air flowing to air volumes, liquid flowing to air volumes or liquid flowing to liquid volumes. When the valve is positioned between air flowing to liquid volumes the siphon 416 may be completely emptied and prevent undesired self-priming of the siphon 416.

More specifically, as illustrated in FIG. 5, the point of fluidic communication between the siphon 416 and the waste chamber 412 may be chosen by actuation of a certain virtual laser valve (VLV) for a desired functionality. A fluidic communication positioned inside the liquid inside the waste chamber 412 (air flowing to liquid volume), actuation of a VLV 500, may prevent accidental priming of the siphon 416. The VLV 500 prevents accidental priming of the siphon 416 because the displacement of the air contained in the siphon 416 requires additional energy for the creation of a bubble. This also means that an excess of a volume of liquid of 250 μL in the purification chamber 402 (liquid flowing to liquid volume) is required in order to prime the siphon 416. This hystheresis property may be beneficial to avoid self-priming of the siphon 416, for example by capillarity.

A fluidic communication positioned outside the liquid inside the waste chamber 412 (air flowing to air volume), actuation of a VLV 502, may allow for easy priming of the siphon 416 as soon as volume of liquid of 250 μL is contained in the purification chamber 402 (liquid flowing to air volume), but also by configurations where capillarity and bubbles are present.

It may be beneficial to position the fluidic communication point, actuation of a VLV, inside the waste chamber 412 to be outside the liquid in the waste chamber 412 in order to start the priming of the siphon 416, and going to be inside the liquid in the waste chamber 412 when the purification chamber 402 has been emptied into the waste chamber 412. This method may allow for keeping the siphon 416 free from liquid droplets. In other words, the creation of a fluidic communication point, actuation of a VLV, in a suitable position in the waste chamber 412 with respect to the liquid in the waste chamber 412 allows modulating the priming of the siphon 416. To a first approximation, the position of the fluidic communication point, actuation of a VLV, inside the waste chamber should not affect the transfer of liquid from the purification chamber 402 to the waste chamber 412 once the priming of the siphon 416 has occurred, at a constant siphon height.

The virtual laser valves may be used to ventilate the macrofluidic structures 302 through the microfluidic structures 304. As illustrated in FIG. 5, actuation of a VLV, for example one or more VLVs 504, fluidly connecting the air volume within the macrofluidic structures may allow the macrofluidic chambers to be ventilated via the microfluidic structures. The ventilation may allow for fluid to flow easily between the macrofluidic structures.

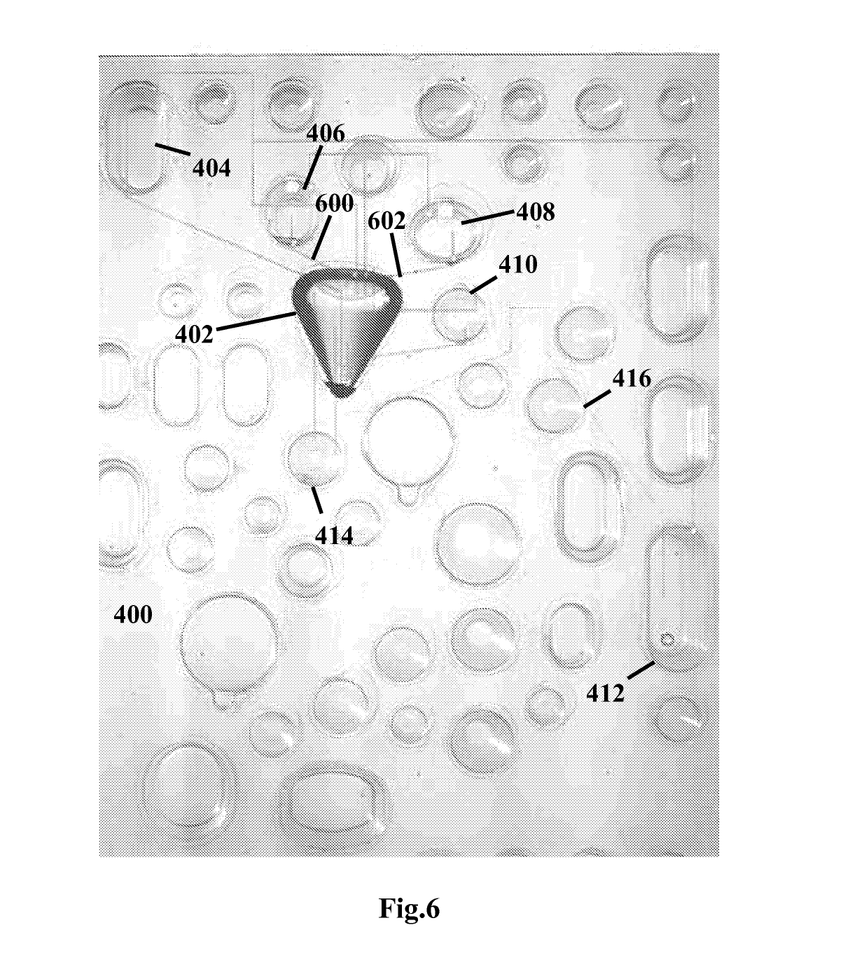

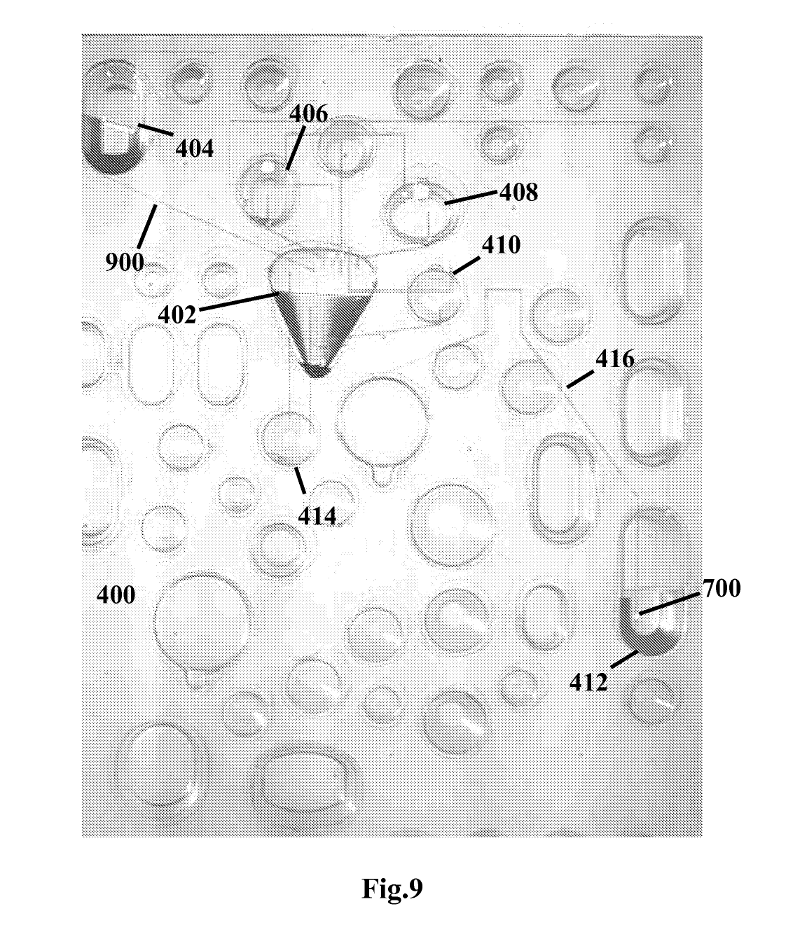

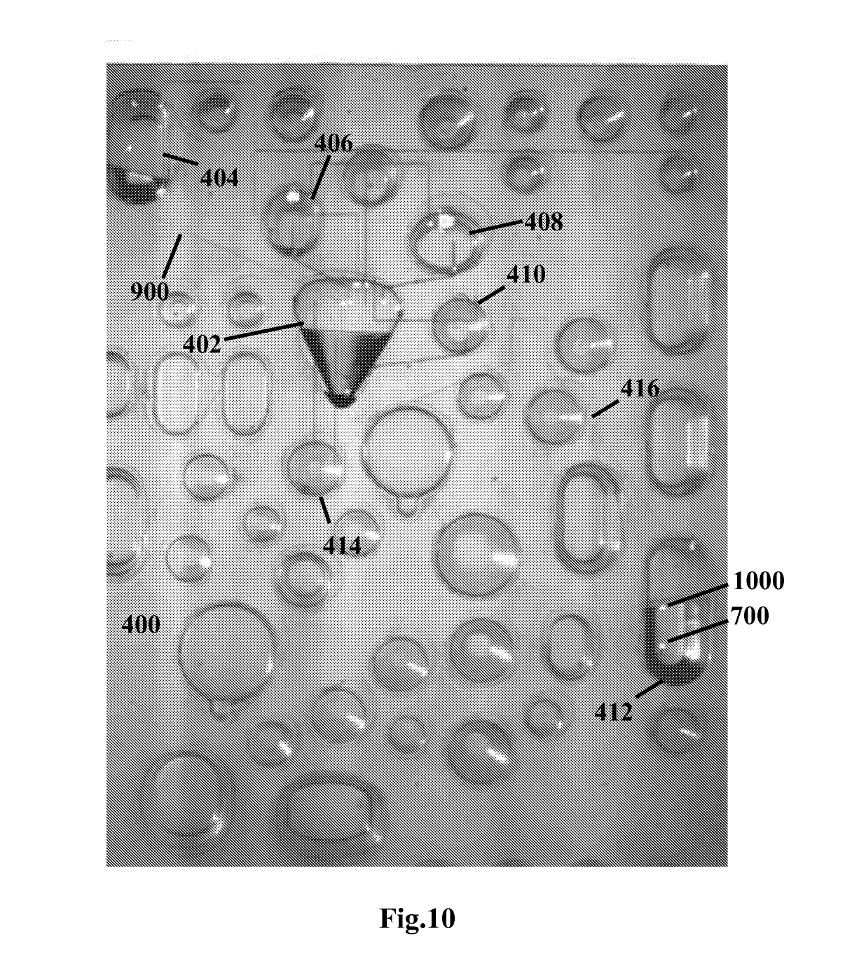

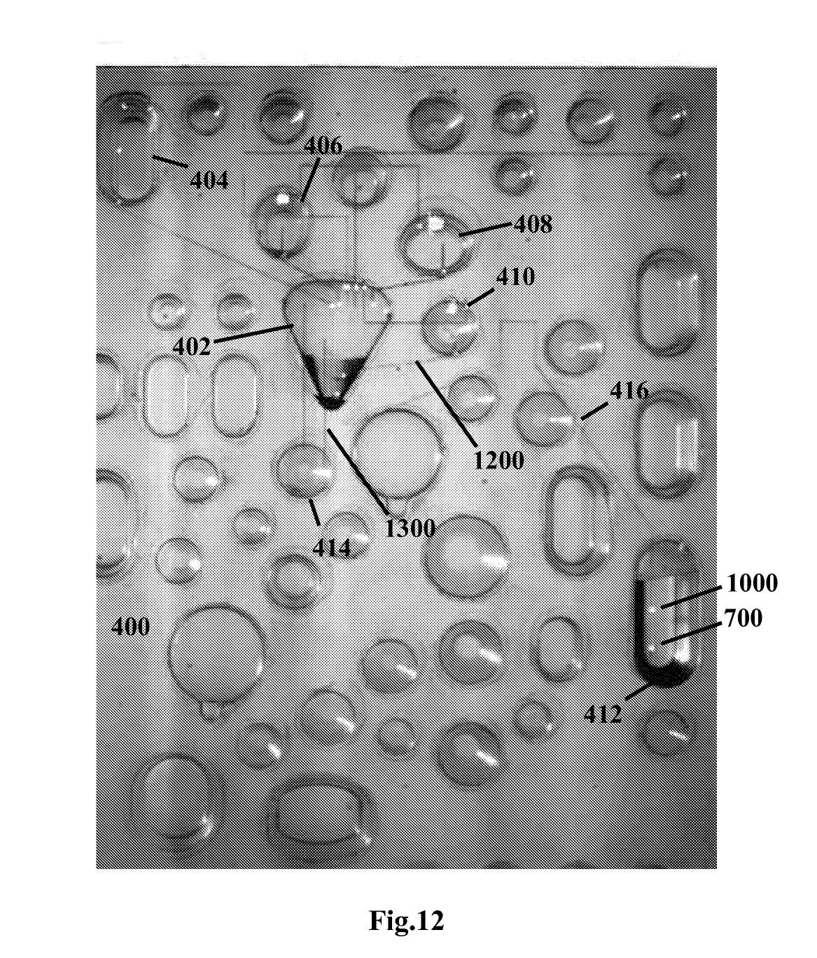

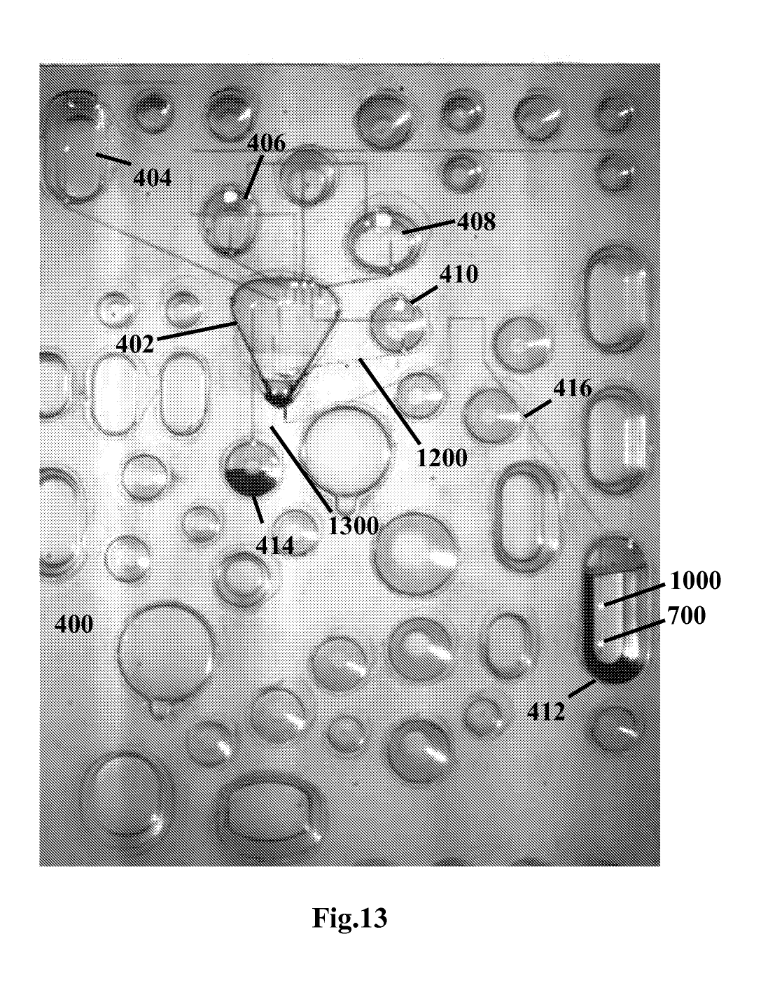

A virtual laser valve regulated siphon washing procedure within the fluidic tile 400 according to an illustrative embodiment is described with reference to FIGS. 6-13. The fluid handling process of the siphon washing method is conducted by the opening of virtual laser valves to place selective chambers in fluid communication, including for ventilation purposes, and the application of a force directed towards the bottom of the fluidic tile 400, such as gravity or inertial acceleration to cause fluid to flow from one chamber to another through a fluid flow path, such as a microcapillary or capillary. Virtual laser valves may be actuated to place the sample chamber 406 containing a sample and the beads chamber 408 containing beads (for example, magnetic or non-magnetic, glass, polystyrene, silica, nanocrystal, polymeric surface and PS streptavidin beads) in fluid communication with the purification chamber 402. The sample contained in the sample chamber 406 may then flow into the purification chamber 402 through the fluid flow path 600. The beads contained in the beads chamber 408 may then flow into the purification chamber 402 through the fluid flow path 602. In the purification chamber 402 the sample selectively interacts with the beads resulting in a portion of the sample binding to the beads.

The flow paths 600 and 602 may communicate with the purification chamber 402 at the top of the purification chamber 402, allowing fluid to flow into the air volume of the purification chamber 402. It should be appreciated that the flow paths 600 and 602 may communicate with the purification chamber 402 at other positions allowing fluid to flow into the liquid volume of the purification chamber 402. Preferably the flow paths 600 and 602 may communicate with the purification chamber 402 at the top of the purification chamber 402, allowing fluid to flow into the air volume of the purification chamber 402 to avoid the risk of fluid flowing back through the flow paths 600 and 602 during subsequent operations.

Additionally, the beads may be packed or pelleted within the purification chamber 402 through the application of a force, such as centrifugation or gravity. The beads may be packed to the desired level by selecting the appropriate duration and speed of centrifugation. The possibility of using the centrifugal force for selectively moving a suspension of beads, or in alternative separating the same beads from the liquid, is enabled by the buoyancy properties of the beads with respect to the liquid itself and the limited diffusion speed of particles with large mass.

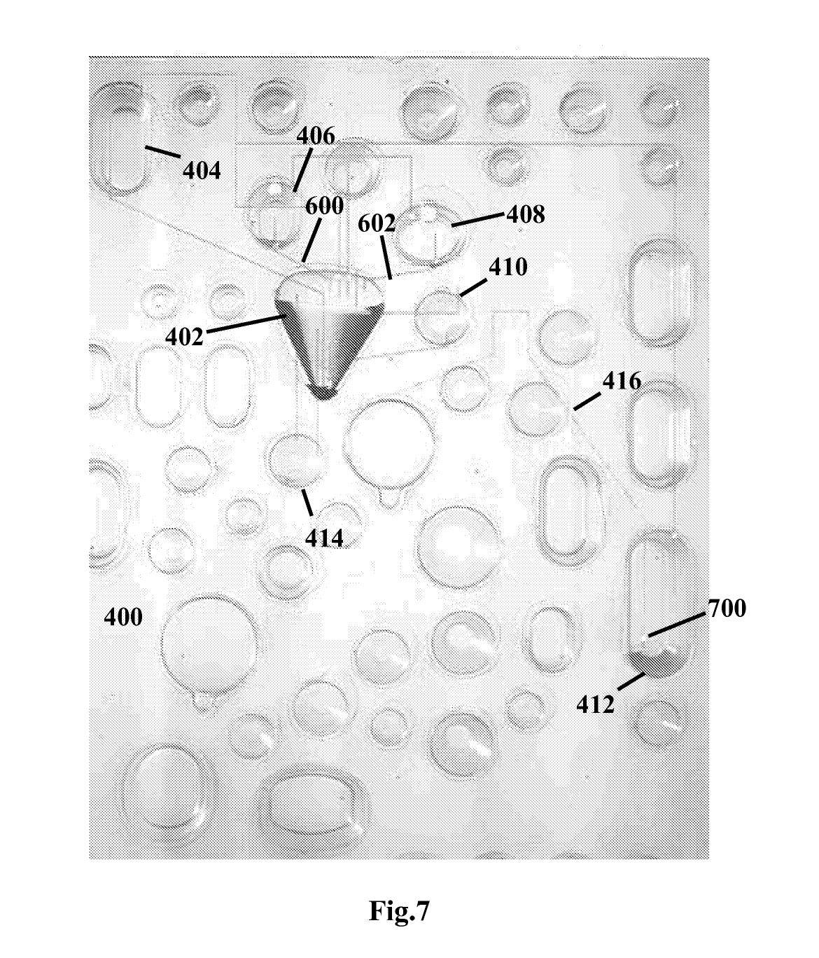

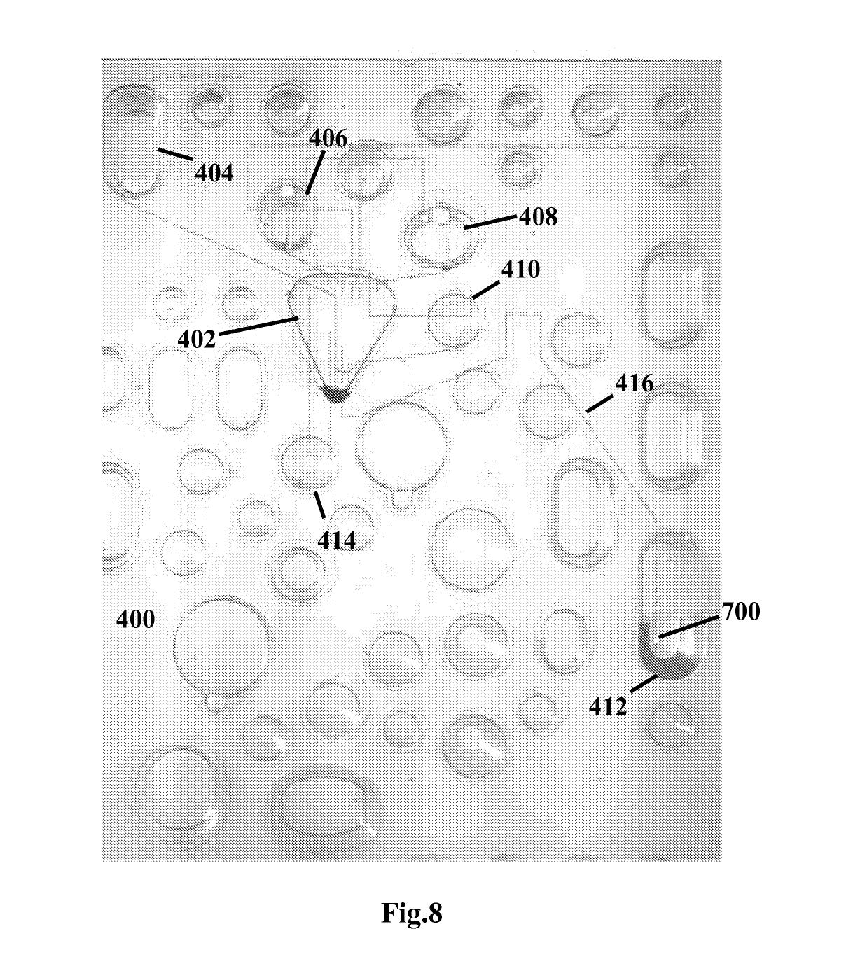

Once the sample has interacted with the beads the remaining supernatant may be extracted. The supernatant may be extracted from the purification chamber 406 and transferred to the waste chamber 412. To extract the supernatant from the purification chamber 402 a virtual laser valve 700 may be actuated to place the purification chamber 402 and the waste chamber 412 in fluid communication through the siphon 416. The point where the liquid in the purification chamber 402 enters the siphon 416 is positioned below the level of liquid in the purification chamber 402 and above the level defined by the volume occupied by the beads in the purification chamber 402 when the beads are pelleted at the bottom of the purification chamber 402. As illustrated in FIG. 6, the purification chamber 402 is approximately full (containing more than 250 μL of liquid). Since the purification chamber 402 contains more than 250 μL of liquid the siphon 416 will be self-primed and initiate flow through the siphon 416. Preferably, the virtual laser valve 700 is initially positioned outside any liquid in the waste chamber 412 (as illustrated in FIG. 7) to allow easy priming of the siphon 416 and later positioned inside the liquid in the waste chamber 412 (as illustrated in FIG. 8) once all the supernatant has bee transferred to the waste chamber 412.

After all of the supernatant in the purification chamber 402 has been transferred to the waste chamber 412, the beads having the sample attached thereto in the purification chamber 402 may be washed. To wash beads having the sample attached thereto in the purification chamber 402 a virtual laser valve may be actuated placing the washing chamber 404 containing a washing buffer and the purification chamber 402 in fluid communication through the fluid flow path 900. The washing buffer in the washing chamber 404 may then flow into the purification chamber 402. The flow path 900 may communicate with the purification chamber 402 at the bottom of the purification chamber 402, allowing the washing buffer to flow through the beads within the purification chamber 402. It should be appreciated that the flow path 900 may communicate with the purification chamber 402 at other positions allowing fluid to flow into the liquid volume, air volume, or the beads within the purification chamber 402. In an illustrative embodiment, the flow path 900 may communicate with the purification chamber 402 at the top of the purification chamber 402, allowing fluid to flow into the air volume of the purification chamber 402 to avoid the risk of fluid flowing back through the flow path 900 during subsequent operations.

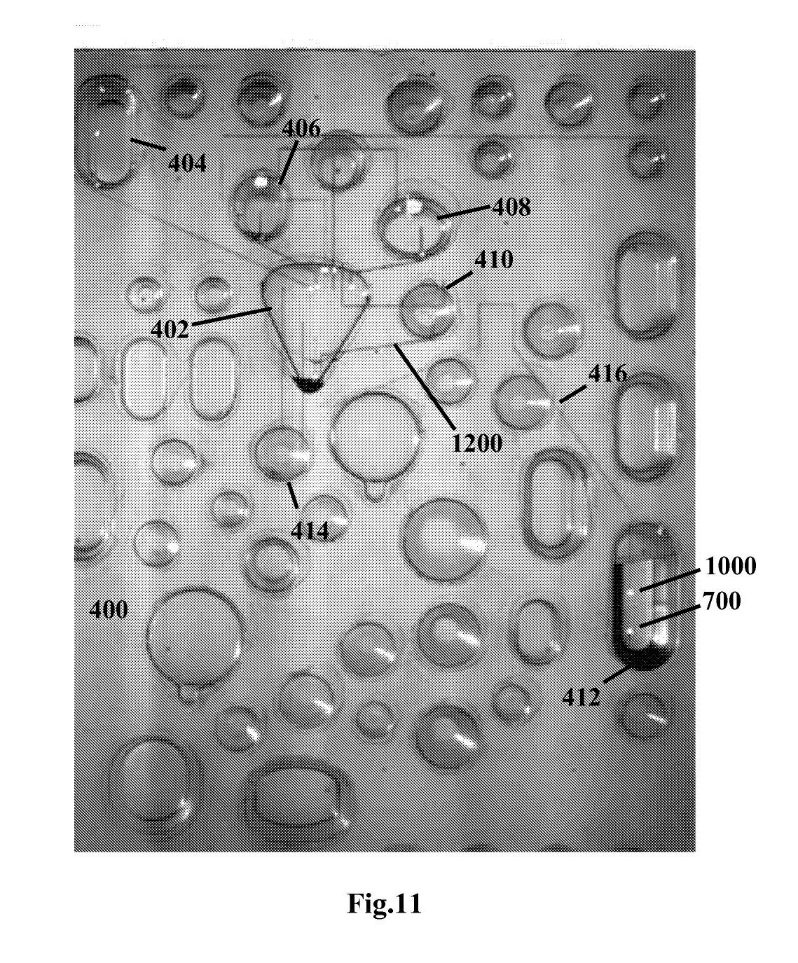

The washing buffer operates to remove any remaining sample that has not interacted with the beads, but should not interfere with the binding properties of the sample attached to the beads. Once the volume of liquid in the purification chamber 402 exceeds 250 μL, the siphon 416 will be self-primed and initiate flow through the siphon 416. Once flow through the siphon 416 is initiated the washing buffer in the purification chamber will be transferred to the waste chamber 412. Additionally, a virtual laser valve 1000 may be actuated and initially positioned outside any liquid in the waste chamber 412 to allow easy priming of the siphon 416 and later positioned inside the liquid in the waste chamber 412 (as illustrated in FIG. 11) once the washing buffer has been transferred to the waste chamber 412.

After the washing buffer in the purification chamber 402 has been transferred to the waste chamber 412, the sample attached to the beads in the purification chamber 402 may be collected. To collect the sample in the purification chamber 402 a virtual laser valve may be actuated placing the elution chamber 410 containing an elution buffer and the purification chamber 402 in fluid communication through the fluid flow path 1200. The elution buffer in the elution chamber 410 may then flow into the purification chamber 402. The flow path 1200 may communicate with the purification chamber 402 at the bottom of the purification chamber 402, allowing the elution buffer to flow through the beads within the purification chamber 402. It should be appreciated that the flow path 1200 may communicate with the purification chamber 402 at other positions allowing fluid to flow into the liquid volume, air volume, or the beads within the purification chamber 402. In an illustrative embodiment, the flow path 1200 may communicate with the purification chamber 402 at the top of the purification chamber 402, allowing fluid to flow into the air volume of the purification chamber 402 to avoid the risk of fluid flowing back through the flow path 1200 during subsequent operations.

The elution buffer operates to interfere with the binding properties of the sample attached to the beads with the consequence of releasing the sample from the beads. Once the sample has been released from the beads, the sample may be collected in the collection chamber 414. To collect the sample in the purification chamber 402 a virtual laser valve may be actuated placing the purification chamber 402 containing the sample in elution buffer and the sample collection chamber 414 in fluid communication through the fluid flow path 1300. The sample in the purification chamber 402 may then flow into the sample collection chamber 414. Once the sample has been transferred to the sample collection chamber 414, the sample may be available to a next step of a protocol or for further processing.

The valve connecting the purification chamber 402 to the flow path 1300, which fluidly connects the purification chamber 402 to the sample collection chamber 414, may be positioned to be below the level of liquid in the purification chamber 402 and above the level defined by the volume occupied by the beads in the purification chamber 402 when the beads are pelleted at the bottom of the purification chamber 402. It should be appreciated that the flow path 1300 may communicate with the purification chamber 402 at other positions within the purification chamber 402. Preferably the flow path 1300 communicates with the purification chamber 402 just above the level defined by the volume occupied by the pelleted beads in the purification chamber 402 to allow collection of the sample while leaving the beads in the purification chamber 402.

Additionally, when completely washing the purification chamber 402 to remove all fluid and/or material in the purification chamber 402, the valve connecting the purification chamber 402 to the flow path 1300 or the siphon 416 may be positioned to be at the bottom of the purification chamber 402. Positioning the valve at the bottom of the purification chamber 402 may allow for the purification chamber 402 to completely empty, including any particulate matter (for example beads), into the sample collection chamber 414 or the waste chamber 412.

The combination of the embodiments previously described enables the transfer of beads suspensions into a given chamber, the distribution of a sample into the same chamber so that the sample can interact specifically with the beads, the selective washing of the sample through siphon washing without removal of the beads from the chamber, the addition of an elution buffer capable of collecting the specific part of the sample which has been captured by the beads, and the collection of the eluate for further processing. This procedure has a number of applications in molecular diagnostics, nucleic acid sample preparation, the performance of immunoassays and the like.

### Manufacture and Processing:

Fluidic tiles according to the embodiments of the disclosure may advantageously have a variety of compositions and surface coatings appropriate for a particular application. Fluidic tile composition will likely be a function of structural requirements, manufacturing processes, reagent compatibility and chemical resistance properties. In particular, the microfluidic substrate and macrofluidic substrate of the fluidic tiles may be made from inorganic crystalline or amorphous materials, e.g. silicon, silica, quartz, inert metals, or from organic materials such as plastics, for example, poly(methylmethacrylate) (PMMA), acetonitrile-butadiene-styrene (ABS), polycarbonate, polyethylene, polystyrene, polyolefins, cyclo olefin polymers, polypropylene and metallocene. These may be used with unmodified or modified surfaces.

Surface properties of these materials may be modified for specific applications. Surface modification can be achieved by such methods as known in the art including but not limited to silanization, ion implantation and chemical treatment with inert-gas plasmas. The fluidic tiles can also be made of composites or combinations of these materials, for example, fluidic tiles manufactured of a polymeric material having embedded therein an optically transparent surface comprising for example a detection chamber of the fluidic tile. Additional elements, for example arrays, detectors, functional devices, gels, could be also integrated into a heterogeneous macrofluidic substrate, making the integration of the device more suitable to given processes.

The fluidic tiles can also be fabricated from plastics such as polyethylene terephthalate (PET), polyethylene terephthalate modified by copolymerization (PETG), Teflon, polyethylene, polypropylene, methylmethacrylates and polycarbonates, among others, due to their ease of moulding, thermoforming, stamping and milling. Further, the fluidic tiles can be made of silica, glass, quartz or inert metal. The fluidic tiles having microfluidic fluidic circuits, capillaries, chambers and the like within one illustrative embodiment can be built by joining using known bonding techniques opposing substrates having complementary macrofluidic chambers, wells, reactors, purification chambers and the like formed therein.

The microfluidic substrate of the embodiments of the fluidic tiles of the disclosure can be fabricated with injection molding of optically-clear or opaque adjoining substrates or partially clear or opaque substrates. The macrofluidic substrate of the embodiments of the fluidic tiles can be fabricated with thermoforming of optically-clear or opaque adjoining substrates or partially clear or opaque substrates. However, thermoforming could be equally applied to the microfluidic substrate, with significant advantages in terms of production cost and capacity, including assembly. Optical surfaces within the substrates can be used to provide a means for detection analysis or other fluidic operations such as laser valving. Layers comprising materials other than polycarbonate can also be incorporated into the fluidic tiles.

The composition of the substrates forming the fluidic tile depends primarily on the specific application and the requirements of chemical compatibility with the reagents to be used with the fluidic tile. Electrical layers and corresponding components can be incorporated in fluidic tiles requiring electric circuits, such as electrophoresis applications and electrically-controlled valves. Control devices, such as integrated circuits, laser diodes, photodiodes and resistive networks that can form selective heating or cooling areas or flexible logic structures can be incorporated into appropriately wired areas of the fluidic tile. Reagents that can be stored dry can be introduced into appropriate open chambers by spraying into reservoirs using means known in the art during fabrication of the fluidic tiles, or simply by means of depositing solid materials. In the alternative or complementing the previous methods, liophilization of reagents on the macrofluidic substrate is an obvious and straightforward solution. Liquid reagents may also be injected into the appropriate reservoirs, before or after the assembly of the microfluidic and macrofluidic substrates, followed by application of a cover layer comprising a thin plastic film that may be utilized for a means of valving within the fluidic circuits within the fluidic tile.

The inventive fluidic tiles may be provided with a multiplicity of components, either fabricated directly onto the substrates forming the fluidic tile, or placed on the fluidic tile as prefabricated modules. In addition to the integral fluidic components, certain devices and elements can be located external to the fluidic tile, optimally positioned on a component of the fluidic tile, or placed in contact with the fluidic tile either while rotating within a rotation device or when at rest with a brick formation or with a singular fluidic tile. Fluidic components optimally comprising the fluidic tiles according to the disclosure include but are not limited to detection chambers, reservoirs, valving mechanisms, detectors, sensors, temperature control elements, filters, mixing elements, and control systems.

Additionally, the fluidic tile may contain a cover film on the outside of the fluidic tile, covering a chamber. The cover film may allow for sample collection or pre-loading sample solutions in to a chamber by puncturing the cover film, which in turn may allow for intermediate storage of the fluidic tile prior to sample collection. Further, the cover film may allow for more efficient and faster radiative heat transfer. The cover film may also allow for optimal optical access to a sample within the chamber.

In an illustrative embodiment, the microfluidic substrate and the macrofluidic substrate of the fluidic tiles of the disclosure can be fabricated by thermoforming a PET/COP/Multilayer or a PP layer. The macrofluidic substrate may contain cavities, for example about 5-50 cavities, that correspond to the capillaries of the microfluidic substrate, wherein the gap between the cavities may be equal to or greater than 1 mm. The macrofluidic substrate could equally be a single piece, or a plurality of substrates with different properties, optimized for example for storage, surface properties, thermal properties, mechanical and electrical performances. In this embodiment, the microfluidic substrate and the macrofluidic substrate are separated by a film layer. The film layer may be a simple unstructured foil having a thickness of about Bum. The film layer may be made of a COP with a carbon black dye. Further, the film layer may be perforated by laser valving to place the capillaries within the microfluidic substrate and the cavities within the macrofluidic substrate in fluid communication. It should be appreciated that sealing of the separate components, the microfluidic and macrofluidic substrates, to keep them from becoming contaminated may be achieved through the use of thermobonding, lamination, pressure sensitive adhesives, activated adhesives, and the like.

In an illustrative embodiment, the film layer or perforation layer may separate the plurality of microfluidic components or structures from the plurality of macrofluidic components or structures or additional components or structures. The structure of the film layer could be homogeneous or heterogeneous, for example including multilayer and coatings. According to the disclosure the film layer or perforation layer may be comprised of a polymeric compound such as Poly(methyl methacrylate), or other material such as Low Density Polyethylene (LDPE), Linear Low Density Polyethylene (LLDPE), High Density Polyethylene HDPE), Polyethylene Teraphathalate (PET), Polyethylene (PE), polycarbonate (PC), Polyethylene Terephthalate Glycol (PETG), Polystyrene (PS), Ethyl Vinyl Acetate (EVA), polyethylene napthalate (PEN), Cyclic Olefin Homopolyers (COP), Cyclic Olefin Copolymers (COC), or the like. These polymers can be used singularly or in combination with each other. The use of polymers is preferred because of its ease of use and manufacturing. It is clear that other options, for example metallic foils with or without additional surface treatment, are possible.

The film layer may further comprise optical dye or other like material or layers having adsorptive properties of pre-selected electromagnetic radiation. The absorption can occur through known modifications as those used in absorbing light filters, for example including metallic foils or modifying the surface optical characteristics (n refraction index and k extinction coefficient) or by means of other surface properties like roughness, in such a way that a sufficient amount of pre-selected electromagnetic energy is absorbed with the consequence of perforation. Other technologies can make use of light absorbing globules, for example carbon-black particles, dye emulsions, nanocrystals. In addition, reflective layers, polarization changing layers, wavelength shifting layers could be used to enhance the effective absorption of electromagnetic energy.

In an illustrative embodiment, the fluidic tile may be pre-loaded with samples, reagents, buffers, biological samples and the like. The purpose of pre-loading the fluidic tile may allow for a user to simply add the sample, reagent, biological sample or the like the user may want to process within the fluidic tile. This may allow for automated processing of a sample, reagent, biological sample or the like within the fluidic tile. The fluidic tile may be stored from temperatures comprised between about −80° C. to about 50° C., about 0° C. to about 50° C., more particularly about 2° C. to about 8° C., or any temperature necessary to preserve the sample, reagent, biological sample or the like pre-loaded within the fluidic tile.

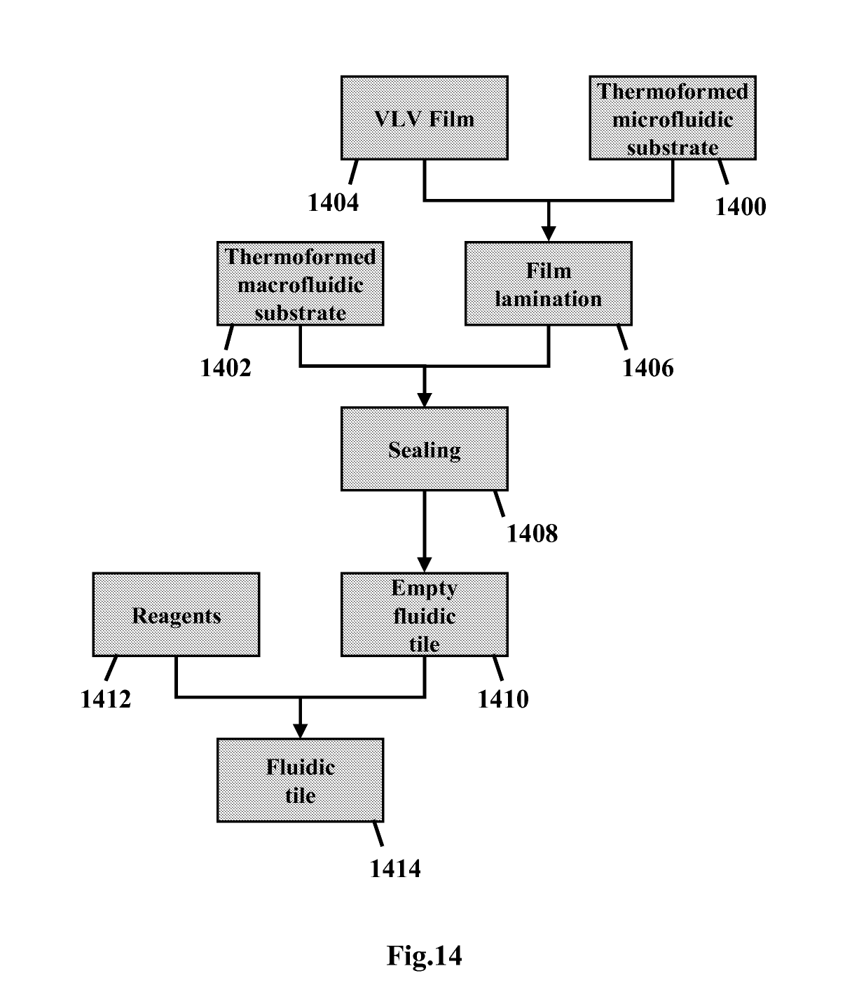

A method of manufacturing a fluidic tile according to an illustrative embodiment, is described with reference to FIG. 14. The microfluidic substrate and the macrofluidic substrate may be thermoformed, illustrated as steps 1400 and 1402 respectively. The substrates may be thermoformed from a polypropylene (PP) foil roll. Then the film layer 1404, virtual laser valve film layer, may be laminated onto the microfluidic substrate, illustrated as step 1406. The film layer 1404 may be laminated on the microfluidic substrate to separate the plurality of microfluidic components or structures from the plurality of macrofluidic components or structures or additional components or structures. Then the microfluidic substrate and macrofluidic substrate may be sealed or bonded together, illustrated as step 1408 to produce an empty fluidic tile 1410 having a dimension of 54 by 86 mm. The microfluidic and macrofluidic substrates are sealed or bonded together with the film layer 1404 separating the microfluidic and macrofluidic substrates. Thus, allowing the microfluidic structures within the microfluidic substrate to be placed in fluid communication with the macrofluidic structures within the macrofluidic substrate upon selective perforation of the film layer 1404.

Alternatively, the film layer 1404 may have a transfer adhesive applied to one or both sides of the film layer 1404. The film layer 1404 may then be sealed or bonded to the microfluidic and macrofluidic substrates to produce an empty fluidic tile 1410 having a dimension of 54 by 86 mm. In an illustrative embodiment, the film layer 1404 has a transfer adhesive applied to the side of the film layer 1404 that faces the thermoformed macrofluidic substrate, after the film layer 1404 has been laminated on the thermoformed microfluidic substrate. The microfluidic and macrofluidic substrates are sealed or bonded together via the transfer adhesive applied to the film layer 1404 with the film layer 1404 separating the microfluidic and macrofluidic substrates. Thus, allowing the microfluidic structures within the microfluidic substrate to be placed in fluid communication with the macrofluidic structures within the macrofluidic substrate upon selective perforation of the film layer 1404.

Further, samples, reagents, buffers, biological sample, and the like may be loaded into the thermoformed macrofluidic structures in the macrofluidic substrate prior to sealing 1408 the thermoformed macrofluidic substrate using the film layer 1404, illustrated as step 1412, to produce a finished fluidic tile 1414. Additionally, the finished fluidic tiles 1414 may be packaged, shipped, and/or stored. The packaging of the finished fluidic tiles 1414 may include cartoning or palleting the finished fluidic tiles 1414. Barcode labels for each sample, reagent, buffer, biological sample, and the like may be placed on the fluidic tile 1414.

The method of manufacturing the fluidic tile 1414 may be implemented on existing processes within the packaging industry, for example using PP foil rolls, transfer adhesive rolls, film rolls, and barcode label rolls. There may also be two lanes, one for thermoforming the microfluidic substrates and one for thermoforming the macrofluidic substrates. Further, modular integration of reagent filling solutions may be implemented to produce a continuous reagent filling line.

In an illustrative embodiment, the fluidic tile may have input ports and output ports which may be sealed by the use of a film layer. The use of the film layer covering the input and output ports is done routinely in drugs discovery when using standard micro-plates between the operation of loading reagents and the actual assay. The film layer prevents contamination and minute quantities of fluid from evaporating, with the consequence of changing their concentration and therefore modifying the assay or process conditions. To input or extract a sample, reagent, biological sample, or the like a user may perforate or pierce the film layer and insert a fluid handling device, such as but not limited to a syringe, vacutainer, and/or pipette, into the input ports and/or the output ports.

The film layer may be the same film layer that may be placed between the microfluidic and microfluidic substrates of the fluidic tile. Further, the film layer can be fabricated from polymeric material, natural rubber, or any material having the feature of being inert to liquids used and pierceable for the introduction of liquids, while maintaining gas tightness afterwards to prevent evaporation of store reagents. The film layer can be obtained by application of a laminated film containing metallic and polymeric layers. The metallic layer allows a low permeability to gas and liquids, and the polymeric layer allows for an easy and effective sealing of the store reagents within the fluidic tile. Further, a combination of two film layers may be used, one of which could coincide with the film layer placed between the microfluidic and the macrofluidic substrate. This double film configuration allows for an improved resistance to possible contamination from nucleic acids or enzymes since one of the films will prevent the other film from being contaminated towards the outside, diminishing the probability of transporting undesired molecules during the operation of sample or reagent loading or unloading in an unprotected environment.

The fluidic tile may have a plurality of input and output ports. The input and output ports may have a length inside the fluidic tile that can be decided arbitrarily accordingly to the fluid volumes to be loaded or extracted and the pitch between successive input and output ports can be chosen accordingly to existing standards and specific integration needs. Nominal pitch values of 2.25 mm, 4.5 mm or 9 mm correspond to the 1536, 384 and 96 wells micro-titre plate standards respectively.

These fluidic tiles could be processed in a variety of systems, including among other centripetal systems. The application of centrifugation allows for liquid transfers when enabled by suitable valves, that could be pre-programmed, actuated at rest, or actuated during rotation.

In an illustrative embodiment, the fluidic tiles may be processed individually or in groups, according to the throughput needs. In this embodiment the fluidic tiles may be loaded at rest and processed through the use of a centripetal system. The centripetal system may be operated in some applications at a predefined temperature, for example 4° C. Two fluidic tiles may be loaded into a rotor within the centripetal system. However, it should be appreciated that any number of fluidic tiles may be loaded into any centripetal system known in the art. The centripetal system may be driven by a constant speed rotor, operating at 600 rpms (10 Hz) for a 75 cm diameter rotor with 32 parallel tests, for asynchronous processing. Alternatively, the centripetal system may be driven by a rotor operating at less than 2000 rpms for a 20 cm diameter rotor. It should be appreciated that it is not required to position the fluidic tiles at a constant distance from the rotation axis, and that the fluidic tiles can be loaded in multiple rows in order to save space.

According to the disclosure, it is preferable to have the input ports facing or closest to the rotation axis. This positioning is desirable since fluids subject to the centripetal acceleration will tend to move radially towards the outer part of the rotor and the input ports can be optimally designed for fluid collection. In this embodiment, the fluidic tiles can be processed on a centripetal platform, that spins in order to position the valve actuator in the correct position, and can move the fluids inside the fluidic tiles by centrifugation. Further, a spinning photodetector may be integrated into the system having a readout time of about 3 seconds. This may include implementation of coaxial rotation of a second “photodetector system” below the fluidic tiles.

The principles, preferred embodiments and modes of operation of the presently disclosed have been described in the foregoing specification. The presently disclosed however, is not to be construed as limited to the particular embodiments shown, as these embodiments are regarded as illustrious rather than restrictive. Moreover, variations and changes may be made by those skilled in the art without departing from the spirit and scope of the instant disclosure and disclosed herein and recited in the appended claims.

1. An apparatus for siphon washing of an assay, comprising:
a purification chamber;
a waste chamber in fluid communication with said purification chamber; and
a washing siphon placing said waste chamber in fluid communication with said purification chamber.

2. The apparatus according to claim 1, wherein said washing siphon has a height between 0 and 33 feet.

3. The apparatus according to claim 1, wherein said washing siphon is primed when a volume of liquid in said purification chamber exceeds about 200 μL.

4. The apparatus according to claim 3, wherein said washing siphon initiates the transfer of said liquid from said purification chamber to said waste chamber when said volume of said liquid in said purification chamber exceeds about 200 μL.

5. The apparatus according to claim 1, wherein said waste chamber is located vertically below said purification chamber.

6. An apparatus for siphon washing of an assay, comprising:
a first substrate comprising at least one macrofluidic structure;
a second substrate comprising at least one microfluidic structure, said at least one microfluidic structure corresponding to said at least one macrofluidic structure in said first substrate; and
a washing siphon forming at least one of said at least one microfluidic structure in said second substrate.

7. The apparatus according to claim 6, further comprising a film layer separating said at least one macrofluidic structure from said at least one microfluidic structure.

8. The apparatus according to claim 7, wherein said film layer is perforable by electromagnetic irradiation.

9. The apparatus according to claim 6, wherein said at least one macrofluidic structure includes a purification chamber.

10. The apparatus according to claim 9, wherein said at least one macrofluidic structure includes a waste chamber.

11. The apparatus according to claim 10, wherein said washing siphon fluidly connects said purification chamber and said waste chamber.

12. The apparatus according to claim 11, wherein said washing siphon is adapted to transfer a liquid from said purification chamber to said waste chamber when a volume of said liquid in said purification chamber exceeds about 200 μL.

13. The apparatus according to claim 6, wherein said microfluidic and macrofluidic structures are selected from the group consisting of capillaries, channels, detection chambers, reaction chambers, reservoirs, valving mechanisms, reaction columns, elution columns, purification columns, purification chambers, detectors, sensors, temperature control elements, filters, mixing elements, and control systems.

14. The apparatus according to claim 6, further comprising at least one input port and at least one output port.

15. A method of siphon washing an assay, comprising:
positioning a washing siphon to fluidly connect a purification chamber and a waste chamber;
actuating at least one virtual laser valve to cause a liquid to flow into said purification chamber; and
initiating fluid flow, by said washing siphon, from said purification chamber to said waste chamber when a volume of said liquid in said purification chamber exceeds about 200 μL.

16. The method according to claim 15, further comprising emptying said liquid from said purification chamber to said waste chamber, via said washing siphon, when said volume of said liquid in said purification chamber exceeds about 200 μL.

17. The method according to claim 16, further comprising actuating a virtual laser valve in said waste chamber in a position initially outside of a liquid in said waste chamber and inside said liquid in said waste chamber when said liquid in said purification chamber has emptied into said waste chamber.

18. The method according to claim 15, further comprising actuating at least one virtual laser valve to cause a sample contained in a sample chamber to flow into said purification chamber.

19. The method according to claim 15, further comprising actuating at least one virtual laser valve to cause beads contained in a beads chamber to flow into said purification chamber.

20. The method according to claim 15, further comprising actuating at least one virtual laser valve to cause a washing buffer contained in a washing chamber to flow into said purification chamber.
